(19) United States
(12) Patent Application Publication
(10) Pub. No.: US 2015/0062572 A1
(43) Pub. Date: Mar. 5, 2015

(54) WHITE CELL FOR FLUID DETECTION

(71) Applicant: Goodrich Corporation, Charlotte, NC (US)

(72) Inventors: Robert Tharaldsen, Sherman, CT (US); Malcolm J. MacFarlane, Brookfield, CT (US); Kenneth Bycenski, Oxford, CT (US)

(21) Appl. No.: 14/185,089

(22) Filed: Feb. 20, 2014

Related U.S. Application Data
(60) Provisional application No. 61/874,048, filed on Sep. 5, 2013.

(51) Int. Cl. G01J 3/02; G01J 3/42

(52) U.S. Cl. CPC G01J 3/021; G01J 3/42
USPC 356/300

(57) ABSTRACT

An optical absorption spectroscopy apparatus includes a field mirror and at least one object mirror configured to reflect transmitted light multiple times between the field minor and the at least one object mirror through a sample volume. At least one fold mirror is configured to allow the transmitted light to double pass across the field mirror. The apparatus can further include a light source and a detector configured to detect an optical absorption spectrum of the light transmitted from the light source through a sample volume.

### CROSS-REFERENCE TO RELATED APPLICATIONS

This Application claims the benefit of U.S. Provisional Application 61/874,048 filed on Sep. 5, 2013.

### BACKGROUND OF THE INVENTION

1. Field of the Invention

The present disclosure relates to optical absorption spectroscopy, and more particularly to use of a white cell to measure fluid properties.

2. Description of Related Art

The concentration of one or more fluid substances (i.e. gases or liquids) within a sample can be determined via optical absorption spectroscopy, by passing light through the sample and detecting the optical absorption characteristics of those substances.

The amount of light absorbed by the substance depends on the concentration of the substance and the path length of light through the substance. In gases, the concentration in terms of molecules per unit volume is generally much lower than in liquids or solids and therefore the path length of the light through the sample must be correspondingly higher. Large path length can be achieved either by placing the light source and the detector far apart or by reflecting the light backwards and forwards through a sample in a measurement cell so that it passes through the sample numerous times before reaching the detector. A multi-pass measurement cell provides a significant path length in an apparatus having a compact form. One example, the White cell named after J. U. White and initially published in “Long Optical Paths of Large Aperture”, Journal of the Optical Society of America, May 1942, which is incorporated by reference in its entirety, has been used for years for absorption spectroscopy.

A typical White cell consists of three concave mirrors of identical radius curvature. A field minor faces two object mirrors. A light source positioned adjacent the field minor transmits light towards the first object mirror which reflects the light back onto the field mirror. The field minor is oriented such that it reflects the light towards the second object minor, which refocuses the light back to the field minor. After a number of passes the light falls off one side of the field mirror and is collected by a detector. This light is then analyzed by a spectrograph to detect the optical absorption spectra of the substances through which the light has passed.

The use of the White cell allows for a relatively long path length in a relatively small volume of space. However, when the frequency of the fluid is greater and/or the path length is increased, the result is several diverging beams of light which create noise or disturbance in the optical absorption spectra.

There is still an ever present need in the art for optical absorption spectroscopy devices and methods that allow for an increased path length in a White cell. There also remains a need in the art for such a devices and methods that are easy to make and use. The present disclosure provides a solution for these problems.

### SUMMARY OF THE INVENTION

An optical absorption spectroscopy apparatus includes a field mirror and at least one object mirror configured to reflect transmitted light multiple times between the field minor and the at least one object mirror through a sample volume. At least one fold mirror is configured to allow the transmitted light to double pass across the field mirror. The apparatus can further include a light source and a detector to detect an optical absorption spectrum of the light transmitted from the light source through the sample volume.

In certain embodiments, the fold mirror can include two minors positioned at approximately a ninety degree angle to each other. The fold mirror can be disposed on the field minor. The fold minor can be angled symmetrically about a normal line to the surface of the field minor.

It is also contemplated that in certain embodiments, the distance between the field minor and the at least one object mirror is equal to or greater than 200 millimeters.

A dual channel optical absorption spectroscopy apparatus includes a first field minor and a second field minor and first and second pairs of object mirrors configured to reflect transmitted light multiple times between the first and second minors through a sample volume. Two fold minors are cooperatively connected to the first and second field minors and configured to allow the transmitted light to double pass across the first and second field mirrors. The first field minor and the first pair of object mirrors are facing each other coaxially to an optical first axis and the second field mirror and the second pair of object mirrors are facing each other coaxially to an optical second axis. The apparatus can further include a light source and two detectors configured to detect an optical absorption spectrum of the light transmitted from the light source through the sample volume. The first and second field mirrors can be disposed perpendicular to each other.

In certain embodiments, the two fold minors can each include two mirrors positioned at a ninety degree angle to one another. The two fold mirrors can be disposed on the two field minors. The two fold mirrors can be angled symmetrically about a normal line to the surface of the respective field mirror.

It is also contemplated that in certain embodiments, the distance between the first field minor and the at first pair of object minors can be equal to or greater than 200 millimeters and the distance between the second field mirror and the second pair of object minors can be equal to or greater than 200 millimeters.

The method for measuring one or more components of a fluid using optical absorption spectroscopy includes reflecting light from a light source multiple times through the fluid in a sample volume using a field minor and at least one object minor. The method can further include double passing the reflected light across the field mirror through a fold minor disposed thereon and detecting the light transmitted to determine the concentration of one or more components of the gas.

It is also contemplated that in certain embodiments, the step of reflecting can further include reflecting light through a terahertz gas.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic plan view showing optical arrangement of a traditional White cell;

FIG. 2 is a schematic plan view showing increased modulation as an effect of increasing the path length while using the optical arrangement of a traditional White cell;

FIG. 3 is a perspective view of exemplary embodiment of a measurement cell constructed in accordance with the present disclosure, showing the use of a fold minor disposed on a field minor;

FIG. 4 is a perspective view of the measurement cell of FIG. 3, schematically showing reduced optical modulation; and

FIG. 5 is a perspective view of another exemplary embodiment showing a dual channel arrangement in accordance with the present disclosure.

### DETAILED DESCRIPTION OF THE PREFERRED EMBODIMENTS

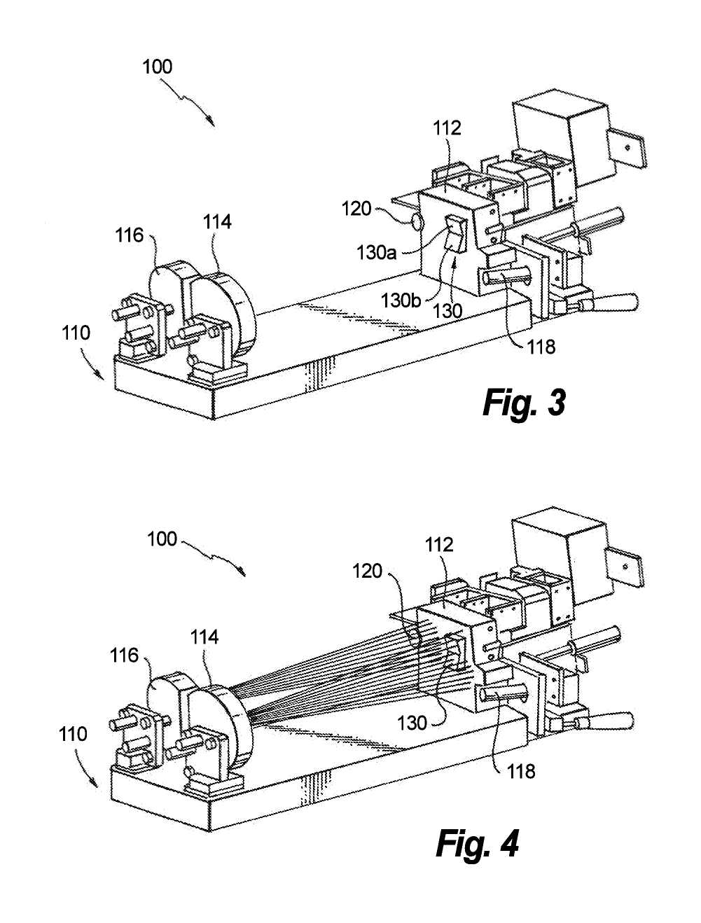

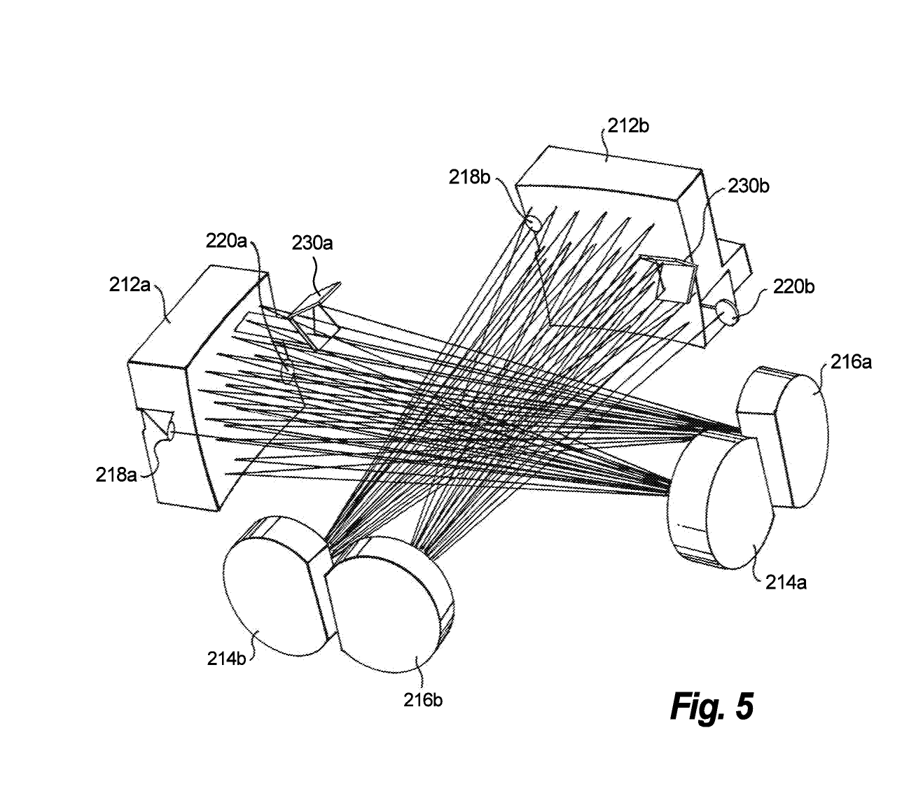

Reference will now be made to the drawings wherein like reference numerals identify similar structural features or aspects of the subject disclosure. For purposes of explanation and illustration, and not limitation, a partial view of an exemplary embodiment of an optical absorption spectroscopy apparatus in accordance with the disclosure is shown in FIG. 3 and is designated generally by reference character 100. Other embodiments of methods and devices in accordance with the disclosure, or aspects thereof, are provided in FIGS. 4 and 5, as will be described. The systems and methods described herein can be used for measuring the concentration of one or more fluid substances and more particularly when the fluid is characterized by increased path length.

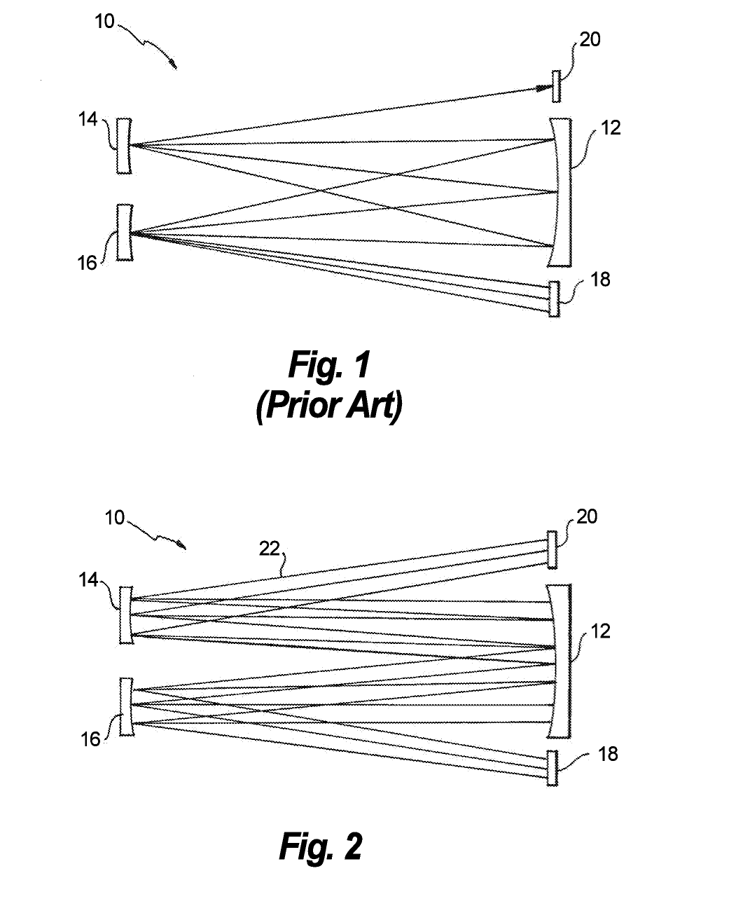

The optical arrangement of a standard White cell 10 is illustrated in FIG. 1. The White cell 10 includes a field minor 12 facing two adjacent object mirrors 14, 16. Usually, the minors are mounted within a measuring chamber (not shown for sake of clarity) having inlet and outlet ports allowing a sample fluid to be introduced into and removed from the chamber. A light source 18 is located adjacent one edge of the field minor 12 and a detector 20 is located adjacent the opposite edge of the field mirror 12. Typically with this optical arrangement, light from the source 18 is focused by the first object minor 16 onto the surface of the field mirror 12. The field minor 12 is oriented such that it reflects the light towards the second object mirror 14, which refocuses the light and reflects it onto the detector 20.

However, when using this technique in the frequency range between a few hundred gigahertz and several terahertz, there is an increased number of diverging beams that overfill the object mirrors 14, 16 as shown in FIG. 2. This in turn causes beams 22 to diverge at the field minor 12 and overlap. This phenomenon causes increased modulation of the final signal. A modulated beam is less observable because of the lack of sufficient signal. This diminishes meaningful detection by the detector 20 because there is increased noise and/or distortion in the signal.

An apparatus 100 for optical absorption spectroscopy according to an exemplary embodiment is shown in FIG. 3. The apparatus, which in this example is designed for analyzing gas samples, includes a White cell housed within a measurement chamber 110. A field mirror 112 is positioned facing two object mirrors 114, 116 at least 200 millimeters from the field minor. A light source 118 and detector 120 are placed on opposing adjacent edges of the field minor 112. A fold mirror 130 is disposed on the field minor 112. As shown in FIG. 3, the fold minor 130 is placed to one side of the field minor 112, but it is contemplated that the fold minor 130 can be disposed on any location on the field minor 112. The fold mirror 130 is defined by two mirrors 130a, 130b coupled at approximately a ninety degree angle from one another. The fold minor 130 is angled symmetrically about a normal line on the surface of the field mirror.

The addition of the fold mirror 130 causes the light beams 122 to make two passes or allows for a double pass across the field minor 112. This technique allows the beams and/or spots on the object minors to spread out, reducing or eliminating overlap and provides a clean signal to detect as shown schematically by the beam lines in FIG. 4. In other words, the light beams 122 that reflect from a first fold mirror 130a will also reflect from the second fold mirror 130b as a true image while allowing the light beam reflections to spread out on the object minors 114, 116. This in turn decreases the amount of beam overlap therefore decreasing modulation while the path length remains the same. Additionally, this embodiment does not require additional space or construction to the measurement chamber.

FIG. 5 illustrates an embodiment of an apparatus 200 having a dual channel configuration. This embodiment allows for placing multiple channels in a minimum volume. Each system can be stacked to achieve a large bandwidth while keeping the total volume of the measurement chamber to a minimum. In this embodiment a first field mirror 212a is positioned facing a pair of first object mirrors 214a, 216a. The first field minor 212a and the pair of first object minors 214a, 216a are coaxially aligned along a first optical axis. Similarly, a second field minor 212b is positioned facing a pair of second object minors 214b, 216a. The second field minor 212b and the pair of second object minors 214b, 216a are coaxially aligned along a second optical axis. Each of the first and second field mirrors 212a, 212b has a respective fold minor 230a, 230b disposed thereon. Additionally, aligned with each of the first and second filed minors 212a, 212b are respective light sources 218a, 218b and detectors 220a, 220b. In this embodiment, the first and second field minors 212a, 212b may be oriented perpendicular to one another and may be stacked.

A methodology of measuring one or more components of a fluid using the optical absorption spectroscopy of the exemplary body is as follows. First, light is reflected from a light source multiple times through the fluid in a sample volume using a field mirror, e.g. field minor 112, and at least one object mirror, e.g. object mirror 116. Using a fold mirror, e.g. fold mirror 130, disposed on the field mirror, the light beams are reflected and double passed across the field minor through a fold mirror. The light transmitted is detected to determine the concentration of one or more components of the fluid. The light is reflected through a gas sample and a good spectrograph signal can then be produced.

The methods and systems of the present disclosure, as described above and shown in the drawings, provide for an optical absorption spectroscopy apparatus with superior properties including measuring the concentration of fluid by reducing the overlap and modulation of the light beams to detect a cleaner signal. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. An optical absorption spectroscopy apparatus comprising:
a field mirror;
at least one object mirror configured to reflect transmitted light multiple times between the field mirror and the at least one object minor through a sample volume; and
at least one fold minor configured to allow the transmitted light to double pass across the field minor.

2. The apparatus as recited in claim 1, further including a light source configured to emit a spectrum of light towards the at least one object mirror.

3. The apparatus as recited in claim 2, further including a detector configured to detect an optical absorption spectrum of the light transmitted from the light source through the sample volume.

4. The apparatus as recited in claim 3, wherein the fold mirror includes two minors positioned at a ninety degree angle to each other.

5. The apparatus as recited in claim 4, wherein the fold mirror is disposed on the field minor.

6. The apparatus as recited in claim 5, wherein the fold mirror is angled symmetrically about a normal line to the surface of the field minor.

7. The apparatus as recited in claim 6, wherein the distance between the field minor and the at least one object mirror is equal to or greater than 200 millimeters.

8. A dual channel optical absorption spectroscopy apparatus comprising:
a first field mirror and a second field mirror;
a first pair and a second pair of object minors configured to reflect transmitted light multiple times between the first and second mirrors through a sample volume; and
two fold mirrors operatively connected to the field minor configured to allow the transmitted light to double pass across the field mirror, wherein the first field minor and the first pair of object mirrors are facing each other coaxially to a first optical axis and the second field minor and the second pair of object mirrors are facing each other coaxially to a second optical axis.

9. The apparatus as recited in claim 8, further including a light source configured to emit a spectrum of light towards the at least one object mirror.

10. The apparatus as recited in claim 9, further including two detectors configured to detect optical absorption spectra of light transmitted from the light source through the sample volume.

11. The apparatus as recited in claim 10, wherein the first and second field minors are perpendicular to each other.

12. The apparatus as recited in claim 11, wherein the two fold mirrors each include two minors positioned at a ninety degree angles to one another.

13. The apparatus as recited in claim 12, wherein the two fold mirrors are disposed on the two field mirrors.

14. The apparatus as recited in claim 13, wherein the two fold mirrors are angled symmetrically about a normal line to the surface of the respective first and second field minors.

15. The apparatus as recited in claim 8, wherein the distance between the first field mirror and the at first pair of object mirrors is equal to or greater than 200 millimeters and the distance between the second field minor and the second pair of object mirrors is equal to or greater than 200 millimeters.
